(19) United States
(12) Patent Application Publication
(10) Pub. No.: US 2005/0266840 A1
(43) Pub. Date: Dec. 1, 2005

(54) Control fixture system and method for remotely controlling devices

(75) Inventors: Jeffrey P. Seefried, Lake Stevens, WA (US); John L. Seger, Brier, WA (US); Bryan L. Sparrowhawk, Monroe, WA (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Leviton Manufacturing Co., Inc., Little Neck, NY (US)

(21) Appl. No.: 11/140,469

(22) Filed: May 27, 2005

Related U.S. Application Data
(60) Provisional application No. 60/575,216, filed on May 27, 2004.

(51) Int. Cl. H04Q 7/20

(52) U.S. Cl. 455/421

(57) ABSTRACT

To assist with patent searching the following description includes a control fixture system used for a controlled device that was originally designed to be controlled by a handheld remote. The control fixture system includes a control module with controls to allow input from a user to operate a controlled device located elsewhere. As mounted, the control module does not share the degree of vulnerability associated with handheld remotes of being misplaced, stolen, or permanently lost. Input modules can be located in the room to couple to audio and/or video sources. The input modules are communicatively coupled to the emitter module, which in turn is communicatively coupled to the controlled device to send audio and/or video signals from the sources to the controlled device.

### BACKGROUND OF THE INVENTION

### DESCRIPTION OF THE RELATED ART

Device control using handheld remotes in some circumstances can be desirable. In other situations, portability of the handheld remotes may cause logistical, operational or other problems. Furthermore, devices designed to be controlled by handheld remotes may be physically located in places where access is limited, which causes difficulties in establishing communication links with other equipment.

### BRIEF DESCRIPTION OF THE SEVERAL VIEWS OF THE DRAWING(S)

FIG. 1 is a generalized schematic diagram of a control fixture system.

FIG. 2 is a generalized schematic diagram of an emitter module.

FIG. 3 is a generalized schematic diagram of an input module.

FIG. 4 is a generalized schematic diagram of a control module.

FIG. 5 is a schematic diagram of an exemplary implementation of the control fixture system.

### DETAILED DESCRIPTION OF THE INVENTION

As will be discussed in greater detail herein, a control fixture system is used for a controlled device that was originally designed to be controlled by a handheld remote. The control fixture system includes a control module with controls such as buttons, knobs, dials, etc. that is mounted typically behind a wall, in an article of furniture or other item. The controls of the control module are typically supported by and accessible through a plate such as a wallplate mounted on a surface of a wall to allow input from a user to operate a controlled device located elsewhere. As mounted, the control module does not share the degree of vulnerability associated with handheld remotes of being misplaced, stolen, or permanently lost. Consequently, the control fixture system can be advantageously used in circumstances and environments where these vulnerabilities of the handheld remotes are pronounced or simply unacceptable.

The control fixture system further includes an emitter module communicatively linked to the control module typically with cables positioned substantially out of room sight behind walls or elsewhere. The emitter module is typically powered by building supplied power and has an emitter that can be located near the controlled device. For example, proximate location of the emitter module is beneficial when the controlled device is designed to be controlled by a handheld remote with signals that are transmitted and received in a substantially direct line of sight between the remote and the controlled device such as where an infrared frequency light source is used.

In the particular cases of infrared or other direct line of sight control, the emitter module can be typically positioned behind a wall or ceiling or otherwise substantially out of view and connected with an external emitter positioned within a room to shine directly on that portion of the controlled device that receives the controlling infrared signal. With other media that have less of a direct line of sight aspect, such as control based on radio frequencies, the emitter of the emitter module may be located less proximate to the controlled device as long as the signal between the emitter of the emitter module can reliably reach the controlled device. The emitter module may still be located relatively near the controlled device for convenience of audio and/or video connection between the emitter module and the controlled device further described below.

The control fixture system also allows for convenient connection between the controlled device and other equipment especially when the controlled device has limited accessibility due to its location. For instance, if a computer or other video and/or audio source were to be communicatively linked to a projector that was mounted to a ceiling, inconvenience would arise due to requirements of routing various audio and video cables from the projector on the ceiling to the computer or video player more near the floor of a room.

This inconvenience would be further exacerbated if the connection to the projector may be on a temporary basis such as in the case where the computer is a laptop that is not permanently assigned to the particular room having the ceiling mounted projector. The control fixture system can afford convenient connection between the controlled device and other equipment by including input modules with input plates, such as wall mounted input plates, supporting input jacks such as for VGA, composite video and multi-channel audio from various audio and/or video sources.

The input modules are communicatively connected to the emitter module via cable typically positioned substantially out of sight, which in turn typically has an output plate with outputs for video and/or audio connections to the controlled device via video and/or audio cables. Other video input jacks can be included with the control fixture system such as s-video or component video depending upon the cabling configuration of the particular implementation.

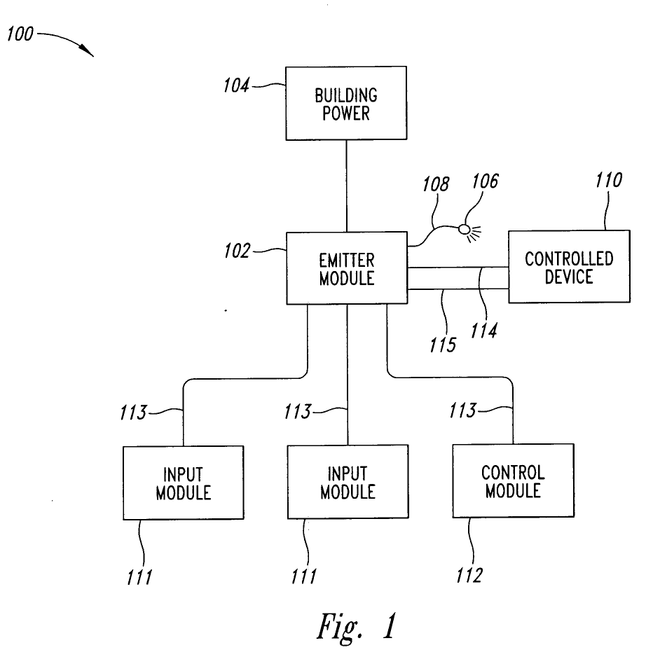

An exemplary depiction of a control fixture system 100 is shown in FIG. 1 as having an emitter module 102 electrically connected with building power 104 to send control signals via an externally positioned emitter 106 connected with the emitter module via a connection cable 108. The control signals from the emitter 106 are sent to a controlled device 110, which includes devices that are originally designed to be controlled via a handheld remote or other type of remote control device.

Controlled devices can include but are not limited to such devices as video projectors, and other audio and/or video playback and/or source equipment. The control fixture system 100 further includes input modules 111 for audio and/or video connection with other equipment (not shown) and a control module 112 for user control of the controlled device 110, which are communicatively linked to the emitter module 102 via cables 113. In some implementations, the cables 113 can include various category rated wire such as category 1, category 3, category 5, category 5e, or category 6 rated untwisted pair cabling.

Other cabling can also be used depending upon the signal specifications involved. For instance, certain video specifications may require S-video cable or component video cable to be used for video portions of the cables 113 between the input modules 111 and the emitter module 102. Video cable 114 and audio cable 115 provide video and audio connection, respectively, between the controlled device 110 and the emitter module 102 to pass on video and audio signals inputted to the input modules 111.

Implementations of the control fixture system 100 can involve controlled devices that are inconveniently located for whatever reason and/or involve situations where use of a handheld remote includes a likelihood for potential problems associated with the portability of the handheld remote. Other uses of the control fixture system can involve other situations in which a mounted control module and/or mounted input modules are desirable.

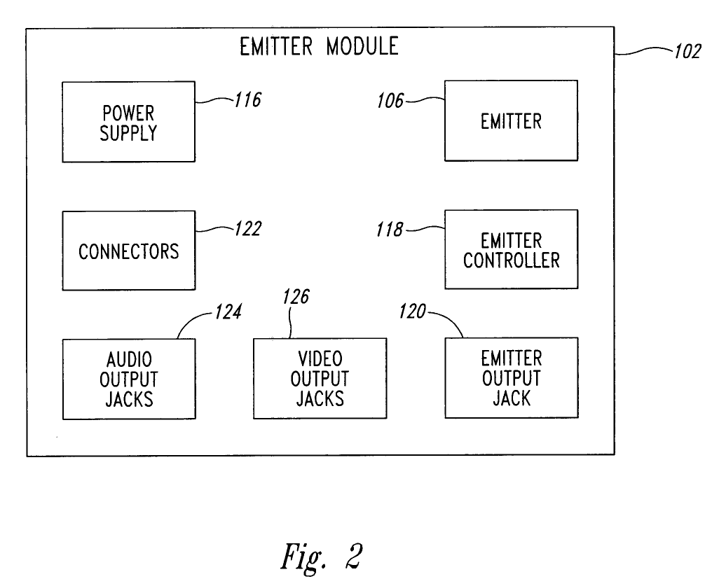

An exemplary depiction of the emitter module 102 is shown in FIG. 2 and includes the emitter 106, which can be externally positioned from the remainder of the emitter module as shown in FIG. 1 or can be positioned internally in the emitter module depending upon the particular types of signals that must be sent from the emitter to the controlled device 110. The emitter module 102 can include a power supply 116 that receives building furnished power either directly as 110/220 volt AC or as DC power through an externally mounted transformer that typically converts 110 or 220 volt AC building power to an exemplary 12 volt DC power.

The implementation of the emitter module 102 depicted in FIG. 2 has an emitter controller 118 which is configured to transmit emitter signals to the emitter 106 to be transmitted by the emitter for controlling the controlled device 110 based on control signals received from the control module 112. In some implementations, the emitter controller 118 in programmed directly during manufacture of the emitter controller to generate various emitter signals based on various control signals received. In other implementations, the emitter controller 118 has a learning mode that is able to program various emitter signals based upon signal input from a particular handheld remote used for the programming. The depicted emitter controller 118 also has storage to retain the various programmed operations to generate the emitter signals. In other implementations, various portions described as being part of the depicted emitter controller 118 may be located in the control module 112.

The depicted emitter module 102 has an emitter output jack 120 that receives a cable for connection to an external version of the emitter 106 such as shown in FIG. 1. The emitter module has connectors 122 to connect to the cables 113, which communicatively link the emitter module to the input modules 111 and the control module 112. The connectors 122 in some implementations can be of a punch down termination-block type or have another insulation displacement style such as for unshielded twisted pair cable. Other types of the connectors 122 are used for other sorts of audio or video cables. The depicted emitter module 102 has one or more audio output jacks 124 to receive the audio cable 115 as depicted in FIG. 1 and one or more video output jacks 126 to receive the video cable 114, also depicted in FIG. 1. The number of cables depends in part upon the capabilities of the controlled device 110.

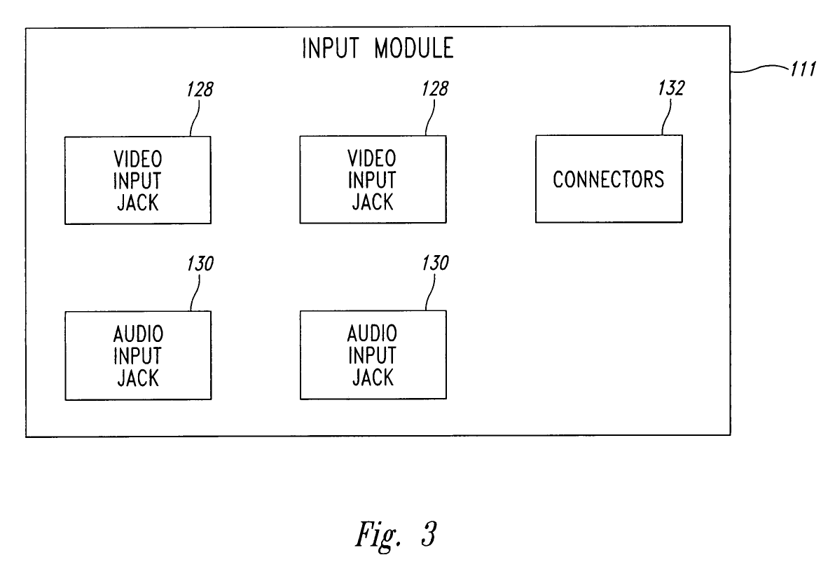

The input module 111 is further depicted in FIG. 3 as having video input jacks 128 and audio input jacks 130. The number and type of the video input jacks 128 and audio input jacks 130 can vary depending upon how many pieces of equipment are planned to be supported at any one time. Depending upon the implementation, the video input jacks 130 can be for composite, S-video, and/or component video. The type of audio input jacks 128 may also vary depending upon the audio specifications being considered. The input module 111 also has connectors 132 to connect to the cables 113, which communicatively link the input module to the emitter module 102. The connectors 132 in some implementations can be of a punch down termination-block type or have another insulation displacement style such as for unshielded twisted pair cable. Other types of the connectors 132 are used for other sorts of audio or video cables.

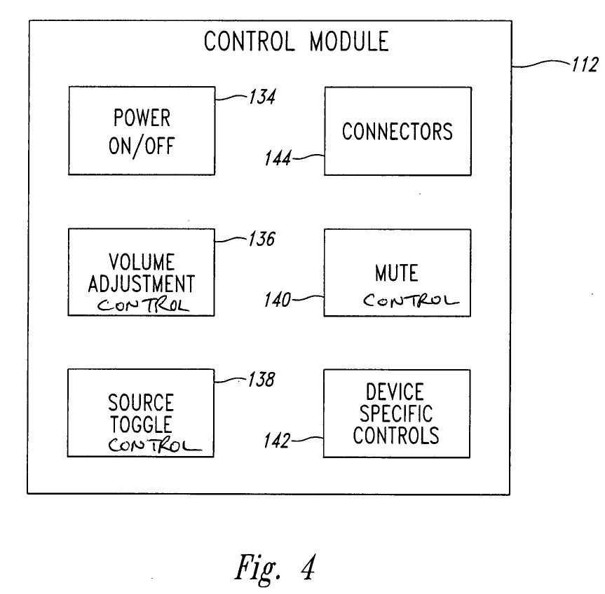

The control module 112 is further depicted in FIG. 4 as having a power on/off control 134, a volume adjustment control 136, a source toggle control 138, a mute control 140, and device specific controls 142. The power on/off control 134 is used for turning the controlled device 110 on or off. The volume adjustment control 136 is used for adjusting volume level of sound being produced by the controlled device. The source toggle control 138 is used for selecting various pieces of equipment that may be connected to one or more of the input modules 111. The mute control 140 is used for temporarily silencing the volume being produced by the controlled device. The device specific controls 142 are used for other functions of the controlled device and may include a sufficient number of controls that the entire functionality control of a particular controlled device may be able to be reproduced through use of the control module 112.

The control module 112 also has connectors 144 to connect to the cables 113, which communicatively link the control module to the emitter module 102. The connectors 144 in some implementations can be of a punch down termination-block type or have another insulation displacement style such as for unshielded twisted pair cable. Other types of the connectors 144 are used for other sorts of control cables.

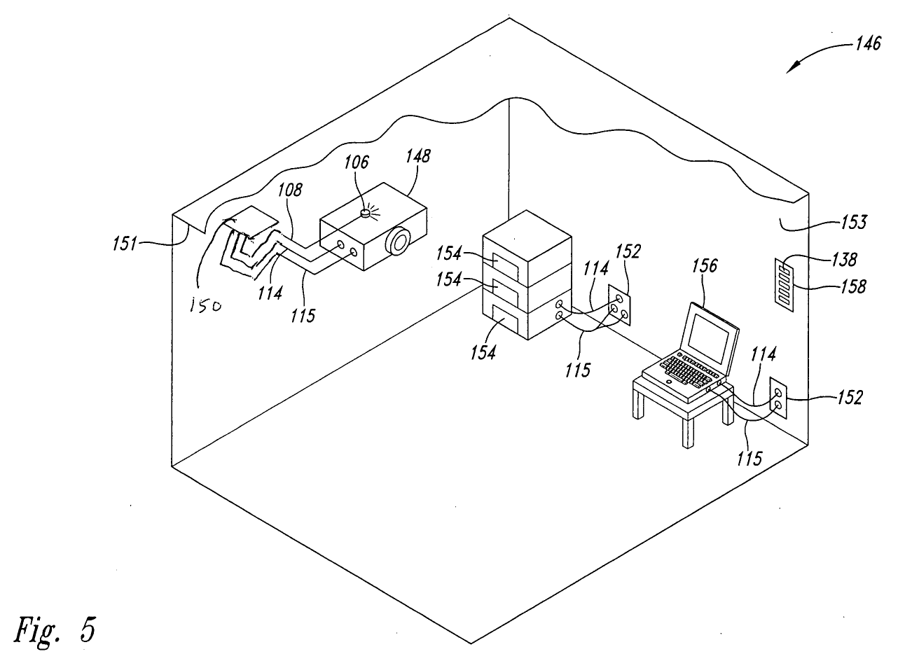

An exemplary implementation 146 of the control fixture system 100 is shown in FIG. 5 in which a projector 148 is connected to the emitter module 102 through an emitter plate 150 attached to a ceiling 151 behind which the emitter module 102 (not shown) is located. The emitter plate 150 supports and exposes to room access the emitter output jack 120, the audio output jacks 124, and the video output jacks 126, and possible external connection of the power supply 116 to the building power 104 through such as an external transformer (not shown). The emitter 106 is shown in this exemplary implementation as positioned with respect to the projector 148 so that signals transmitted from the emitter 106 can be received by the receiver device (not shown) located typically within the projector to control operation of the projector.

Input plates 152 are mounted on a wall 153 behind which the input modules 111 (not shown) are located. Audio and/or video equipment 154 and a computer 156 are connected to the video input jacks 128 and the audio input jacks 130 of the input modules 111. The input plates 152 support and expose to room access the video input jacks 128 and the audio input jacks 130 of the input modules 111. The outputs of the equipment 154 and the computer 156 are presented one at a time by the projector 148 according to a selection controlled by the source toggle control 138 of the control module 112 (not shown) located behind the wall 153. The source toggle control 138 is supported and exposed to room access by the control plate 158 mounted on the wall.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. For a controlled device configured to be controlled by receiving wireless control signals from a handheld remote, a system comprising:
a control module having controls, the control module configured to generate input control signals based upon operation of the controls by a user, the control module configured to be mounted in a stationary location at a first distance from the controlled device; and
an emitter module separate from the control module and configured to mounted in a stationary location at a second distance from the controlled device, the second distance being smaller than the first distance, the emitter module including an emitter and an emitter controller, the emitter configured to transmit emitter signals substantially similar to a portion of the wireless control signals, the emitter module configured to be communicatively linked by cable to the control module, the emitter controller configured to receive the input control signals from the control module and configured to generate the emitter signals to be transmitted by the emitter based upon the input control signals received from the control module.

2. The system of claim 1 wherein the control module is configured to be mounted behind a wall of a room and wherein the controls are positioned for access at a wallplate mounted to the wall.

3. The system of claim 1 wherein the controls of the control module include association with volume control of the controlled device and activation of the controlled device.

4. The system of claim 1 wherein the emitter module and the control module are configured to be communicatively linked via unshielded twisted pair cable.

5. The system of claim 1 wherein the emitter is configured to transmit the emitter signals in an infrared frequency range.

6. The system of claim 1 wherein the emitter is configured to positioned externally from other portions of the emitter module and is communicatively link to the emitter controller via a cable.

7. The system of claim 1 wherein the emitter module is configured to receive building supplied power.

8. The system of claim 1 wherein the controls include push buttons.

9. For a projector configured to emit sound and light, aspects of the sound and light emission controlled by wireless control signals received by the projector, a system comprising:
a control module having controls, the control module configured for coupling to a wall of a room with the controls being accessible from within the room; and
an emitter module including an emitter and an emitter controller, the emitter configured to transmit emitter signals substantially similar to a portion of the wireless control signals, the emitter module configured to be located more in proximity to the projector than to the control module and to be communicatively linked to the control module, the emitter module configured to generate the emitter signals to be transmitted by the emitter based upon operation of the controls of the control module.

10. A system comprising:
a controlled device configured to be controlled by receiving wireless control signals from a handheld remote;
a control module having controls, the control module configured to generate input control signals based upon operation of the controls by a user, the control module configured to be mounted in a stationary first location; and
an emitter module including an emitter and an emitter controller, the emitter configured to transmit an emitter signal substantially similar to a portion of the wireless control signals, the emitter module configured to be communicatively linked to the control module, the emitter controller configured to be mounted in a second location closer to the controlled device than the first location and configured to receive the input control signals from the control module and configured to generate the emitter signals to be transmitted by the emitter based upon the input control signals received from the control module.

11. A system comprising:
a projector configured to emit sound and light, aspects of the sound and light emission to be controlled by wireless control signals received by the projector;
a control module having controls, the control module configured for coupling to a wall of a room with the controls being accessible from within the room; and
an emitter module including an emitter and an emitter controller, the emitter configured to transmit emitter signals substantially similar to a portion of the wireless control signals, the emitter module configured to be located closer in distance to the projector than to the control module and configured to be communicatively linked by cable to the control module, the emitter module configured to generate the emitter signals to be transmitted by the emitter based upon operation of the controls of the control module.

12. For a controlled device configured to be controlled by receiving wireless control signals from a handheld remote, a system comprising:
a control module having controls, the control module configured to send input control signals based upon input from operation of the controls, the control module configured to be mounted in a stationary location;
a input module including an input jack to communicatively couple with a device to receive and send a device signal from the device; and
an emitter module including an emitter and an output jack, the emitter configured to transmit emitter signals substantially similar to a portion of the wireless control signals, the emitter module configured to be located closer to the projector than to the control module and the input module and configured to be communicatively linked to the control module and the input module, the emitter module configured to generate the emitter signals to be transmitted by the emitter based upon the input control signals received from the control module, the emitter module configured to send the device signal to the controlled device coupled to the output jack.

13. The system of claim 12 wherein the device signal is one of the following: an audio signal and a video signal.

14. The system of claim 12 wherein the output jack is one of the following: an audio jack and a video jack.
